(19) United States
(12) Patent Application Publication
(10) Pub. No.: US 2002/0143627 A1
(43) Pub. Date: Oct. 3, 2002

(54) Network banner advertisement system and method

(76) Inventors: Jonathan Barsade, New Haven, CT (US); Steven Y. Cho, Sherman Oaks, CA (US); Adam Zell, Los Altos, CA (US)

Correspondence Address: INNOVAR, LLC, P O BOX 250647, PLANO, TX, 75025, US

(21) Appl. No.: 09/867,223

(22) Filed: May 29, 2001

Related U.S. Application Data
(60) Provisional application No. 60/279,707, filed on Mar. 30, 2001.

(51) Int. Cl. G06F 17/60; H04N 7/025

(52) U.S. Cl. 705/14; 725/32

(57) ABSTRACT

A network advertising system and method includes a network server, a computer user, an electronic banner advertisement (BA) file, multiple web page files, a BA program, and a monitor. The BA is displayed on the monitor in a window of a browser program from about the point in time that a new web page is requested to about the point in time that the web page file corresponding to the new web page is downloaded onto the user computer and ready for viewing. The BA offers an advertising venue that will serve up a very discernible advertisement, uncluttered by other content that captivates the viewer's interest, at a point of time that a web (Internet or other network) surfer is willing and amenable to review additional data and information. This is typically a down-time during a browser session. However, by displaying the advertisement as described, most web surfers will indeed pay attention to the ad and the message that it is providing.

### FIELD OF THE INVENTION

The present invention relates generally to a system and method of advertising on a network, and more specifically, to a system and method of generating a full or partial page banner advertisement during an Internet browser session.

### BACKGROUND OF THE INVENTION

During the year 2000, companies spent approximately $8.2 billion in on-line advertising. Strictly online companies, such as PlanetRX, Boo.com, MotherEarth.com, WebVan, X.com, eToys, DrKoop.com, applied almost all of their capital towards on-line marketing campaigns for market education purposes, resulting, in some cases, in more than a $100 per customer acquisition cost. In many of these cases, the customers produced only a few dollars in return purchases for the companies. Consequently, about fifty web sites accounted for more than 90% of on-line advertising revenue. To maximize effectiveness, most of the advertising dollars were directed towards those web sites with the highest levels of traffic. For example, out of the more than 1,700 web sites that vied for advertising revenue, about 71% of on-line advertising revenue was generated by the top 10 web sites.

To date, traditional, non-e-commerce companies have not diverted significant funds towards on-line advertising. These companies have tended to spend their advertising funds in traditional advertising media, including print and broadcast. For example, in September 2000, the 10 largest U.S. companies spent less than $50 million (just over 3%) of a total of $1.6 billion spent in on-line marketing. Some companies such as GE, Boeing, and Citigroup, spent less than a million dollars each in on-line marketing.

One of the reasons that companies are reluctant to invest in on-line advertising is the lack of the apparent effectiveness of this advertising medium in generating return sales. The advertising banners included on most web pages are small and inconspicuous and are typically not readily discernible in a web page cluttered with graphics, texts and links. The conventional advertising banner is also generally undesirable to a viewer of a web page as it takes up space on the web page that the viewer would rather view without the banner, thereby forcing the surfer to: (i) pro-actively split his focus between the page s/he is interested in reviewing (the substantive web page) and the banner; and (ii) where possible, click out of the banner. Anyone surfing the web is undoubtedly familiar with those mind-numbing moments of staring aimlessly at the computer screen, momentarily shifting the glaze nervously to the bar at the bottom of the web browser, which is the only indication that indeed the computer system is trying to locate and serve-up (download) the requested page, praying that all the wait will not be in vain, and that an error message will not be the ultimate result. In 1998 alone, web surfers spent a total of 2.5 billion hours waiting for web pages to download¹. A significant amount of the time it takes to download a web page can be due to the downloading of advertising banner(s) included in the web page rather than the downloading of the desired content of the web page.

The traditional banner ad is also cumbersome to use since a web surfer that clicks on the ad is typically taken away from the main site where s/he was surfing, forcing her/him to reconstruct the main web-surfing session.

Companies are also reluctant to spend capital on on-line advertising because of the disadvantages it possesses as compared to traditional print and broadcast media advertising. In broadcast media, the ad is delivered in discrete program breaks, assuring the advertiser of the full attention of the viewer. In print media, advertising is typically measured in full, half and quarter page sizes, assuring the advertiser of an advertisement that is readily distinguishable from the surrounding content. In the on-line banners that are currently used, the advertising information, as measured in pixels, would take up less than 2% of a comparable printed page, and in many instances, much less than that. With their comparatively small size and lack of ability to capture a reader's interest, the conventional banner ad is not an effective advertising medium for the Internet. ¹Business2.0. The average load time can range from 4 seconds per page (using DSL and broadband capabilities) to 7-8 seconds (when using standard 56 k dial up modem).

U.S. Pat. No. 6,141,010 to Hoyle discloses a computer interface method and apparatus with targeted advertising. The method and apparatus provide an automatically upgradeable software application that includes targeted advertising. A software application includes a GUI that includes a display region used for banner advertising that is downloaded from the Internet periodically. The advertisement to be displayed to a computer user is related to software applications on the user's computer.

U.S. Pat. No. 6,216,112 to Fuller et al. discloses a method and system for offering and distributing software wherein advertisements are incorporated into the software product. The advertisements are stored in the random access memory of the computer whenever the software is invoked and are displayed before the software can be used. The advertisements are periodically refreshed by automatically accessing computer servers on the Internet and downloading and installing the advertisements on the hard disk of the computer.

U.S. Pat. No. 6,161,142 to Wolfe et al. discloses a system and method for delivering programmed music and targeted advertising messages to Internet based subscribers. The system includes software that relates advertising to musical content according to a subscriber's practices. The subscriber receives the programmed music and matched advertisements from the repository over the Internet.

Accordingly, a need remains for an on-line advertising system and method that overcomes the disadvantages of the known banner advertising systems. Such a system would provide increased banner advertisement content while not significantly increasing, and perhaps decreasing, the amount of time it takes for a desired web page to download to a computer.

### SUMMARY OF THE INVENTION

The system and method of the invention seeks to overcome the disadvantages inherent in the conventional banner advertising systems and methods used on the Internet. The present system provides an advertising banner which content is clearly distinguishable from the content of a target requested web page. The banner ad of the invention is viewed between requested web pages, i.e., it is viewed during the time period in which a first web page is being removed from a browser window and a requested second web page is being downloaded onto a computer and ready for viewing in the browser window. Upon completion of the downloading of the requested web page, the advertising banner closes, recedes behind the requested web page or maintains a position in front of the requested page. In either case, the banner ad of the invention assumes a secondary role as compared to the completely downloaded content of the requested page, so that an Internet user can view at least a major content of the requested web page.

In one embodiment, the banner ad is a full page banner ad (FPBA) that takes up at least a major portion of, or preferably at least almost the entire content of, a standard sized web page. In another embodiment, the banner add is a partial page banner ad (PPBA) that takes up less than a major portion of the entire content of a standard sized web page. Since a web page can comprise one or more frames, the banner ad will generally comprise at least the entire content of a frame. The BA can occupy more than one frame of a single window. Depending upon the embodiment of the invention, the frame containing the banner ad will occupy a minor portion, a major portion or the entirety of a web page.

The banner ad is downloaded a first time from an Internet server onto and stored in the memory of the computer of a web user (web surfer). This download occurs as a background download, so that its occurrence will not disrupt a surfer's viewing of a requested web page. The banner ad can be available for viewing immediately after its first download onto the web user's computer. Alternatively, it is served up from the computer's memory to a web page and viewed during the time period that a web user is waiting for another requested page to download.

Because of the timing of its download and its serving up to the browser, the banner ad takes advantage of the time period during which the web surfer is an interested and captive audience, i.e., the period that occurs during downloading of a requested web page. During this period the web surfer is more open to possible diversions from his main surfing activities.

The system and method of the invention provides a non-disruptive advertisement that is quick, efficient and effective in delivering its message, preferably lacking substantive non-advertising content that may be of more interest to the user.

The banner ad software can include a visible progress bar indicating the status of delivery of a requested page, thereby providing a web surfer with an indication of the status of the download of the requested web page and confirming that his computer system is working concurrently on loading the requested page. The banner ad software could take information gathered from the browser software and from heuristics applied to incoming data streams in order to determine the level of progress made in downloading the requested page. The progress bar of the BA will incorporate data from the progress bar that is used by the Internet browser monitoring the progress of downloading of the requested page. Alternatively, the progress bar can obtain download status data also by evaluating the amount of data downloaded into the browser or by evaluating the amount of time that has elapsed since submittal of the request for the requested page. The BA progress bar may function when the BA is activated by web page changes that do not require a change of domains. In the case of a change of domains, the progress bar may be deactivated or appear in the form of an icon indicating that activity is taking place, but without a clear indication of the precise status of downloading of the requested web page. The BA program can be modified to incorporate features that enable the progress bar to be fully activated also during web page changes that occur in the transfer to a different domain. As used herein, the term “network data stream” refers to a web page data stream that is not the intended advertisement data stream, which may also be referred to as an advertisement file.

The claimed banner ad (BA) generally overcomes the disadvantages of the standard banner ad in that: (i) a BA occupies approximately the entire space of the window of a browser session, except for the tool bars, for example, thus eliminating the undesirable effect that surrounding unwanted content has on the effectiveness of the advertisement; (ii) the claimed banner ad is served up only at effective down-time, such as in between the serving up of different pages or when the web surfer is otherwise awaiting the down load of a requested page; (iii) clicking on the claimed banner ad will result in an independent browser session that will open up the advertising site, without disrupting the main surfing session; and/or (iv) the claimed banner ad permits the advertiser to provide a condensed and more appealing message that can integrate concise audio and video presentations utilizing flash technologies, or other such technologies, which presentations are not available in traditional banner ads that have size and environment constraints, and which do not conflict or otherwise interfere with the content of the main web page. Unlike the banner ad of the invention, conventional banner ads typically only include a simple graphic, text and/or a simple animation.

The BA of the invention can be located in the same window of a browser session in which a web user is awaiting downloading of a requested web page or it can be located in a different browser window, such as part of a separate browser session that is not the part of the browser session in which the web user is awaiting downloading of a requested web page.

### BRIEF DESCRIPTION OF THE DRAWINGS

The following drawings are part of the present specification and are included to further demonstrate certain aspects of the invention. The invention may be better understood by reference to one or more of these drawings in combination with the detailed description of the specific embodiments presented herein.

FIG. 1 depicts an exemplary network of user computers and Internet servers that can be used to practice the method of the invention.

FIG. 2 depicts a general flow chart of the steps that occur during the method of the invention.

FIGS. 3a-3b depict exemplary logic flow charts that describe the system and method of the invention as it occurs on the computer of a user.

FIGS. 4-6 depict exemplary logic flow charts that describe a subroutine of the system and method of the invention as it occurs on a server in communication with the user's computer.

### DETAILED DESCRIPTION OF THE INVENTION

The BA of the invention requires a user's computer and a network server. The user's computer stores one or more BA file of the invention at a time, whereas the network server stores many different BA files of the invention. The banner advertisement of the invention can be an audible advertisement, a viewable advertisement or an audible and viewable advertisement.

A BA file according to the invention can comprise one file or a cluster of files or other forms of data streams used in computer network communications. For example, a web page generally comprises a cluster of graphics and text files as well as embedded scripts. As used herein, the term “BA file” refers to a single file or a cluster of files, or other forms of data streams used in computer network communications, that together comprise the content of the BA when viewed on the window of a browser. The cluster of files that comprise the BA file can be referred to as an html file, which file generally comprises a cluster of other file types that are downloaded sequentially or concurrently onto a user's computer. Exemplary file types include html, text file, graphics file, executable script, java script file, active-X file, flash file, multimedia file, video file, music file, audio file, CGI script, macro-media director file, Real file, QuickTime file, mpeg file, tiff file, gif file, pdf file, MIDI file, plug-in file and others known to those of ordinary skill in the art.

A BA file is downloaded onto a user computer before, during or after the user has requested and received a (first) web page. The BA file is notdisplayable, i.e., not served up to a user browser window, however, until after the user has requested a second web page. Shortly or immediately after the request for the second, or another, web page has occurred, the BA file is served up to and is displayable in a browser window. If the BA occurs in the same browser window as that of the previously viewed or just requested web page, the BA assumes a dominant position in the browser window until download of the just requested web page is complete. At that point, the BA assumes an inferior position and the requested web page is served up to and viewed in the browser window. If the BA occurs in a window that is different than the window in which the previously viewed web page occurred or in which the just requested web page will occur, the window with the BA assumes a dominant position over the requested page window until download of the requested page is complete. At that point, the window with the BA assumes an inferior position with respect to the window with the just requested web page. By the term “displayable” is meant that the advertisement created with the BA data stream (or file) will be visible and/or audible to an operator of a user computer. When the BA data stream creates an audible advertisement, the BA data stream is “displayed” by rendering it audible to a user through a speaker or other sound-generating component associated with the user computer. When the BA data stream creates a viewable advertisement, the BA data stream is “displayed” by rendering it viewable to a user through a monitor or other visual signal-generating component associated with the user computer. When the BA data stream creates an audible and viewable advertisement, the BA data stream is “displayed” by rendering it audible and viewable to a user as described herein by way of one or more components associated with the user computer. Accordingly, a display component of a user computer is either a monitor, speaker, headphone, projector or other such conventional components typically operably engaged with a user computer.

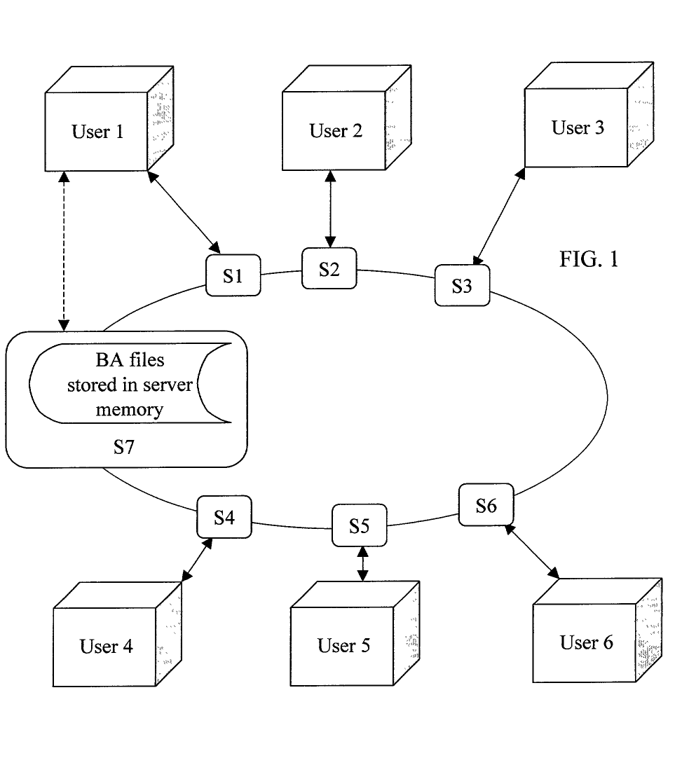

FIG. 1 depicts an exemplary network comprising plural user computers (User 1 - User 6) and network servers (S1-S7). The server (S7) includes a memory (information storage medium) comprising stored BA files. The network can be an external network, such as the Internet, or an internal network, such as an Intranet. The users access the network through normal channels such as a T1 line, telephone modem, computer modem, cable modem, DSL modem, fiber optic cable, wireless modem, and such other access means that are commonly known in the industry of computer networks' access technologies. For example, User 1 accesses the Internet by using a computer modem connected to a telephone to connect to the Internet server S1, which belongs to an Internet Service Provider (ISP). User 2 accesses the Internet by connecting to the server (S2) via a cable (TV) modem. User 3 accesses the Internet by connecting to the server (S3) with a T1 line, and so on. Alternately, a user can access the server (S7) containing the BA files directly, as shown by the dashed arrow, using any of the above-mentioned methods. Where the system is an Intranet, the server (S7) can be the central or a peripheral server.

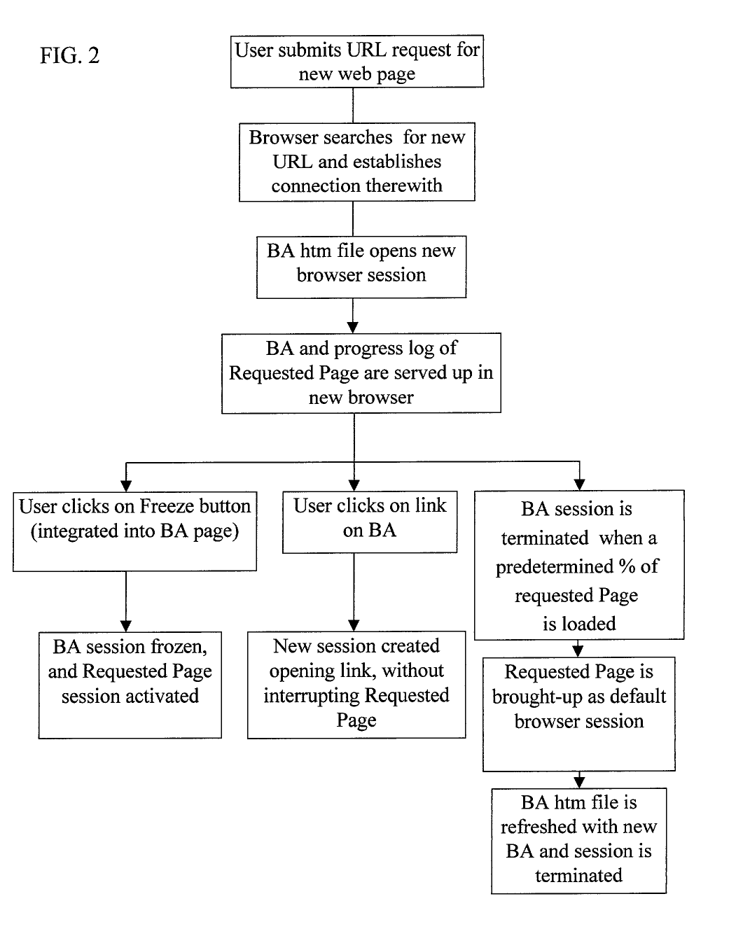

FIG. 2 depicts a general schematic of the steps involved in the system and method of the invention as they can occur during a browser session on the Internet or other computing network system, for example. After a user has connected to the computer network and has a browser window open, he submits a request for a specific web page using any of the conventional procedures, such as by clicking on a link, or entering the URL (Uniform Resource Locator) address of the web on the address bar of the browser window. After receiving the request, the browser program searches the network for the requested web page and establishes a connection with it. As the requested web page is being downloaded onto the user computer from a server, the BA program of the invention opens a banner ad file previously downloaded onto the user computer. The banner ad file is served up to a window of the browser. The program of the invention provides a status bar that can depict the status (such as percent downloaded or number of files downloaded or number of files yet to be downloaded or that the files are in the process of being downloaded) of the downloading of the requested page. While the banner ad window is open, the web user has several options available to him. He may freeze (pause) the banner ad window, request another web page via the banner ad window or close the banner ad window. Other options may also be available. These options are elected by entering keyboard commands, using the graphic user interface, utilizing voice commands, retinal scanning systems, clicking on one or more active links placed within the banner ad window in a manner similar to the placement and activation of hyperlinks in standard network web pages or utilizing such other methods commonly used for communicating between the user and the computer. When the banner ad window is frozen, the user can proceed to the requested web page window, while keeping the banner ad window open. The user can request another web page via the banner ad window by clicking with a mouse on an active link in the banner ad window. By doing so, the browser program begins to search the network for the just requested page. The newly requested page can be downloaded into the same window as the banner ad or into another window. Once a predetermined percentage or amount of the first requested page has been downloaded onto the user computer, or after a predetermined time period has lapsed, the banner ad window closes and the window with the first requested page is served up. While the first requested page is being viewed by the user or being downloaded onto the user's computer, the original banner ad file is replaced on the user's computer with another one. In other words, the BA file replacement occurs in the background preferably without disrupting the user's viewing of the first requested page.

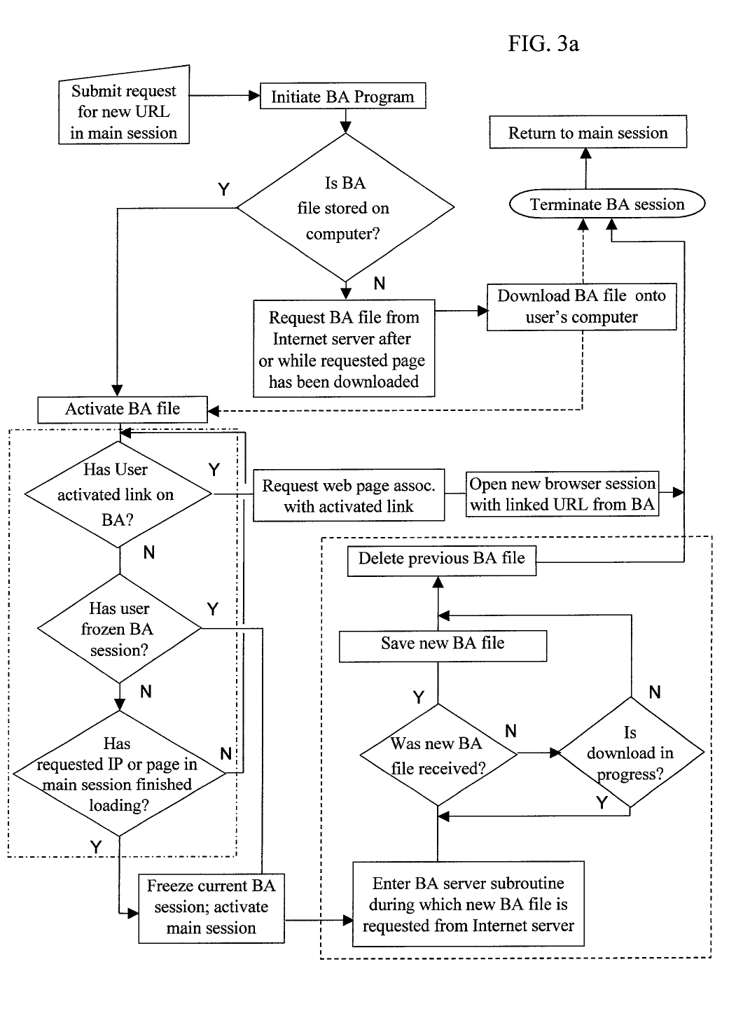

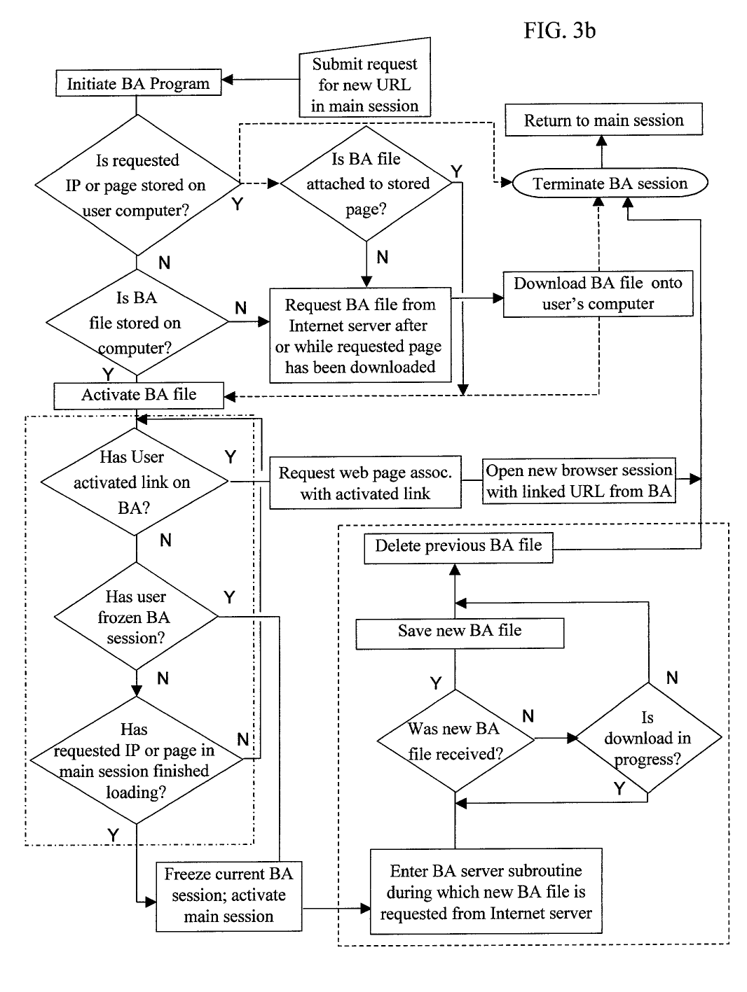

FIG. 3a depicts a more detailed logic flow chart for a program that is used with the system and method of the invention. As with FIG. 2, this logic flow chart begins once the web user has requested a new web page. The BA program is initiated after the user's request. The BA program then determines whether or not a BA file is already stored on the memory of the user's computer. If it is, the BA file is activated, and the BA is displayed on the user's monitor, either in the same window as his current web page or in a window that is separate from the one of his current web page. If the BA file is not already stored on the user's computer, the BA program waits for completion of the download of the requested web page and, or concurrent with download of the requested web page, then requests a BA file from the server having BA files stored therein. The BA file is downloaded onto the user's computer while the user is viewing the requested web page; therefore, download of the BA file does not interfere significantly with the user's viewing of the requested web page. The downloaded BA file can be stored in the memory of the user's computer for up-loading to the browser at a later time. Alternatively, once downloading of the BA file is complete, the BA program either terminates, or the BA file is uploaded to a browser window shortly after its downloading is complete.

If the BA program detects a previously loaded BA file on the user's computer, the file is activated and the BA is served up to the window of the browser. While the BA is viewable in the window, the BA program determines whether or not: 1) downloading of the requested web page has completed; 2) time out has occurred; 3) the user has frozen the window containing the BA; or 4) the user has activated a link on the BA. The four determinations can be made in any order and need not be made in the order set forth above or depicted in the box defined by the dot-dash line of FIG. 3a. If downloading of the requested web page is complete, if a time out has occurred or if the user has frozen the BA, the BA program pauses the BA session and returns the browser program to the main session that includes the just requested web page. If the user has activated a link in the BA, the BA program requests the web page associated with that link and opens a new browser window for that web page, and the main browser session returns to the just requested web page. Upon opening of the new browser window, the BA session terminates.

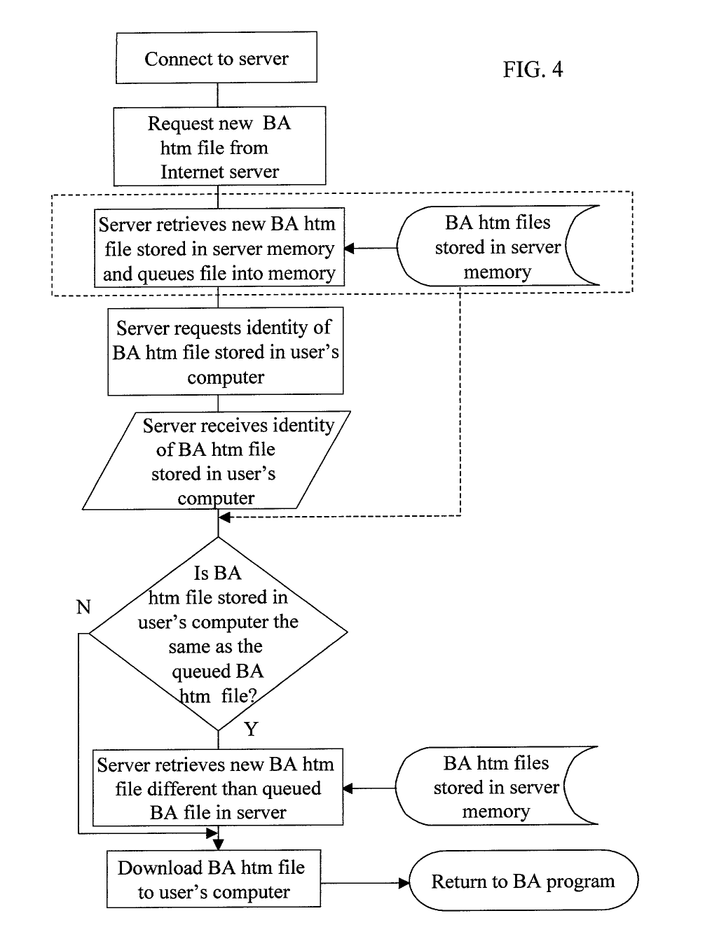

If the BA window has been paused (frozen), the BA program enters into a background mode of operation as depicted in the box defined by the dashed line of FIG. 3a. These steps occur while a user is viewing the requested web page in the main (first) browser session. The BA enters a BA server subroutine (or macro), during which the user's computer communicates with the server as described in FIGS. 4-6 and the user's computer requests a new BA file from the server containing BA files. The BA program then determines whether or not the new BA file has been completely downloaded. If not, it determines whether or not the download is in progress. If it is no longer in progress, the session has presumably frozen and the previous BA file is deleted. The program repeatedly requests the status of the download of the new BA file until it is complete. Upon completion of the download of the new BA file, the BA program deletes the previous BA file and the BA session is terminated.

One or more active links can be included in a BA according to the invention. Suitable active links include all types of links known in the field of Internet programming and web pages. An active link can include an ACTIVE-X™ control, FLASH™ control, flash animation, image, macro-media director file, real, QuickTime, MPEG, MIDI, executable files and such other files that are commonly known in the industry of software programming. An active link is activated, by a viewer of the BA, by employing either a mouse (graphic user interface device), commands and/or the keyboard. Activation of an active link will cause the opening of a different browser session, which will open with the web page requested by such active link. The main browser program will then return to the main session that includes the just requested web page.

The BA program includes an optional feature to pause (or freeze) the BA. Pausing the BA program will prevent the BA session from terminating, but will not interfere with the loading process of the requested page session. The ‘freeze’ button will be integrated into the BA page. Upon activating the ‘freeze’ button, the user will be able to return to the main session while keeping the BA in the background (relative to the main browser session), activate a link on the BA page, or terminate the BA session.

An alternative embodiment of the logic flow chart is depicted in FIG. 3b, which differs from FIG. 3a in the part of the chart that precedes the step of activating the BA file. As with FIG. 3a, the logic flow chart of FIG. 3b begins once the web user has requested a new web page. The BA program is initiated after the user's request. The BA program then determines whether or not a file corresponding to the requested web page is already stored in the memory of the user's computer. If it is, the BA program can be terminated, as indicated by the dashed arrow. Alternatively, if the web page file is stored on the user's computer, the BA program then determines whether or not there is a BA file attached to the web page file. If it is, then the attached BA file is activated. If it is not, then the BA program waits for completion of the download of the requested web page and, or concurrent with download of the requested web page, then requests a BA file from the server having BA files stored therein. If a file corresponding to the requested web page is not already stored in the memory of the user's computer, the computer determines whether or not a BA file is stored in the memory of the user's computer. If it is, the BA file is activated, and the BA is displayed on the user's monitor, either in the same window as his current web page or in a window that is separate from the one of his current web page. If the BA file is not already stored on the user's computer, the BA program waits for completion of the download of the requested web page and, or concurrent with download of the requested web page, then requests a BA file from the server having BA files stored therein. The BA file is downloaded onto the user's computer while the user is viewing the requested web page; therefore, download of the BA file does not interfere significantly with the user's viewing of the requested web page. The downloaded BA file can be stored in the memory of the user's computer for up-loading to the browser at a later time. Alternatively, once downloading of the BA file is complete, the BA program either terminates, or the BA file is uploaded to a browser window shortly after its downloading is complete.

The BA server subroutine that is part of the BA program is available in a number of different embodiments, some of which are depicted in FIGS. 4-6. Each of the BA server subroutines begins when the session (window) for the BA has frozen, as depicted in FIGS. 3a-3b. Although referred to herein as a subroutine, the BA server subroutine can also be a macro CGI script for the BA program and such other subroutines commonly known in the industry of Internet software programming. In the subroutine depicted in FIG. 4, the BA program requests a new BA file from the server containing plural stored BA files. The server retrieves a BA file from its memory and queues the file. The server then requests the identity of the BA file stored in the user's computer. Once the user's computer responds with the identity of its BA file, the server determines whether or not the new BA file is the same as the BA file already stored in the memory of the user's computer. If the two BA files are the same, the server retrieves a different new BA file and downloads it onto the user's computer. If the BA file on the user's computer and the queued new BA file are different, the server downloads the queued new BA file onto the user's computer. Upon completion of the BA server subroutine, the BA program returns to its main logic flow chart as depicted in FIGS. 3a-3b. In the embodiment of FIG. 4, the user's computer initially requests an unidentified BA file, i.e., the identity of the requested BA file is not specified. In other words, the user's computer merely sends a generic request for a BA file.

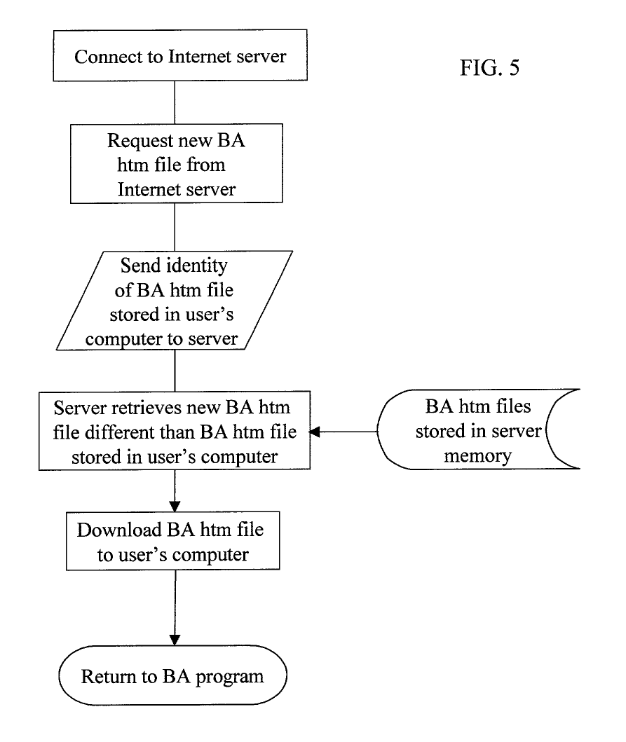

In the subroutine depicted in FIG. 5, the BA program requests a new BA file from the server containing plural stored BA files. The user's computer then sends the identity of its stored BA file to the server. The server then retrieves a new and different BA file from its memory and downloads it to the user's computer. Upon completion of the BA server subroutine, the BA program returns to its main logic flow chart as depicted in FIG. 3. As with the embodiment of FIG. 4, the user's computer in this embodiment initially requests an unidentified BA file, i.e., the identity of the requested BA file is not specified.

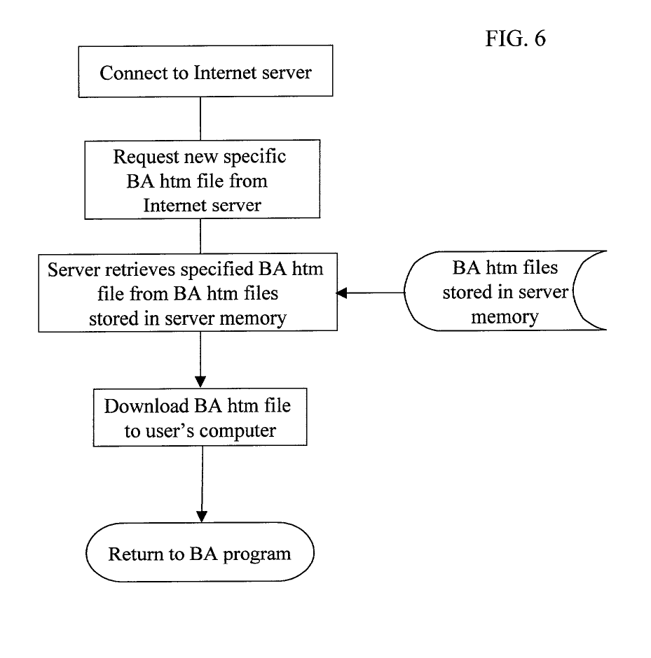

Since the embodiments of FIGS. 4-5 do not request a specific BA file, the content of the new BA file may or may not be related to the requested web page or the web page that the user was just viewing or the BA of a competitor of the host of the web page might unfortunately appear. It is possible, however, for the user's computer to request a specific BA file such that the host of a website or web page can specify a particular BA thereby enhancing the marketing of a good or service. In the subroutine depicted in FIG. 6, the BA program requests a specific (predetermined identity) new BA file from the server containing plural stored BA files. The server then retrieves the specified BA file from its memory and downloads it to the user's computer. Upon completion of the BA server subroutine, the BA program returns to its main logic flow chart as depicted in FIGS. 3a-3b.

Given the potentially diverse content of the BA files, they can be categorized into and/or indexed according to classes, subclasses, genera, groups and/or subgroups. Alternatively, they can be identified according to unique identifiers, such as unique URL's addresses. A BA file can, therefore, be requested according to a class, subclass, genus, group, and/or subgroup to which the BA file belongs. Likewise, the BA file can be requested according to its unique identifier. In other words, the BA program can request a specific BA file, or it can request an unspecified BA file, which is a member of a specific group, subgroup, class, subclass, and/or genus of BA files.

The identity of the specified BA file can be determined according to a number of methods. For example, a web page that a user is currently viewing might include embedded command language specifying the identity of the BA file to be requested. Accordingly, while the web page is being viewed, the BA program obtains the identity of the specified BA file from the web page and sends its identity to the network server by way of the BA server subroutine described above. The command language embedded in the web page may be java script, applet or such other command languages commonly known in the industry of Internet web page programming.

Alternatively, the identity of the specified BA file can be determined by information stored on the user's computer in the form of a cookie, which information can be called upon to determine the identity of the specified BA file. The identity of the specified BA file can also be determined by the origination and address of the requested web page or by information stored on a server or other centralized computing system in the form of data that can be called upon to determine the identity of the specified BA file.

The content of a specified BA file may be related to the content of the web page that a user was viewing or has requested; however, it need not be so.

The BA window can include a header identifying it as an “advertisement”, so as to reduce consumer confusion between the ad, and the requested web page.

Click-on capabilities (e.g. hyperlinks) may be added to the BA. When a hyperlink is activated, a new browser session will be opened (so as not to disrupt the main surfing session), and the user will be linked as per the click-on request.

The BA program may enable the storing of multiple BA files on the user's computer, in which case the BA program will request specific BA files. BA files will be replaced by subsequent specific BA files, or the BA program may cause their deletion after predetermined time periods.

If a user computer or a network server fails to execute any of the command language included in the browser program, BA program, BA server subroutine or other such software, the respective program can be terminated by a user. Alternatively, the program is terminated by the computer by including in such programs conventional termination sequences and command language. For example, the BA program can include a termination sequence to occur after a predetermined time period, or the failure to load of the requested web page.

The advertising system and method of the invention is generally intended for use in marketing any good or service. In one embodiment, the BA program is provided to licensees or subscribers of an advertisement service provider (AdSP), which network servers include the BA files. The BA program is stored on a network server and run temporarily on a connected user computer. Alternatively, the source code for the BA program is included in a web page. The BA program may be in the form of programming language, such as java script or applets, which are incorporated into the web page, or such other script or software language commonly known in the network communications programming industry. Such script includes programming language that submit requests to the BA server to submit BA files that are attached to the web page. Such script includes additional programming language that enable the BA features otherwise described, including instructions to not be viewable while the first web page is being viewed by the user, to launch the BA file upon submitting the request for the requested second web page and the ability to freeze the BA file. By integrating the BA activation code into the web page, licensees will have ultimate control as to when and how the BA is launched. The BA program would be activated when surfing web pages published by licensees who sign onto the advertising service, and accept the AdSP's licensing terms. Alternatively, the BA program is activated when surfing (going) from a licensee web site to a non-licensee web site because it will have been activated by the code incorporated into the licensee's page.

In general, the system and method of the invention may be used to conduct e-commerce under any of a number of scenarios. Under one scenario, an advertisement service provider (AdSP) has one or more servers containing banner ad files. An e-commerce company (EC) having a business website subscribes to the ad-serving business of the AdSP. The website of the EC includes one or more web pages and one or more of those web pages includes a BA program and respective activation code embedded in the page. The BA program on a web page includes a request for a specific BA file from the server of the AdSP. A first-time customer of the EC connects to the web page having the embedded BA program. While a viewer is viewing the EC's we page, the BA program obtains a BA file from the server of the AdSP and downloads it onto the user's computer. When the user requests another web page the BA program is activated and the BA file is served up to a browser window, while the user is waiting for the content of the requested web page to download. After download of the requested page is complete, the BA is superceded by the requested web page, and the BA program continues along its intended logic path.

Income may be generated by charging a licensee (subscriber) a royalty each time a BA file is downloaded onto a user computer. For example, the licensee is charged a fee (F) of $X or Y cents each time the BA file Z is downloaded onto a user computer. So the royalty (R) would be determined as follows: R=n×F, wherein n is the total number of times that the BA file Z was downloaded from the server onto a user computer during a given time period. The value n is determined by using a counter (software and/or hardware) associated with the network server to keep track of the number of times a specific BA file is downloaded onto a user computer, which may or may not necessarily be the same user computer. Alternatively, a counter (software and/or hardware) could be associated with the user's computer to keep track of the number of times and the identity of BA files downloaded and viewed by the user.

Computers now have embedded within them an electronic processor serial number. If a user computer has the processor serial number activated, the server of the AdSP can be modified to include a program that tracks the number of times a specific user computer downloads specific BA files. By doing so, the AdSP is able to obtain valuable marketing data regarding the on-line habits of specific users. Moreover, the AdSP will be able to determine which users click on which types of BA's and what topics are of interest to specific users.

Any network, in particular Internet, browser program can be used. Suitable browser programs include MICROSOFT™ Internet Explorer, NETSCAPE™ browser, AMERICA ONLINE™ browser, PRODIGY™ browser and other such programs.

The memory in which the BA file or web page file is independently stored includes both volatile and non-volatile memory. The files can be stored in the random access memory (RAM), a memory cache, floppy disc, magnetic tape, magnetic storage devices, optical storage devices, DVD, CD, hard drive, ZIP™ DISC and such other memory systems that are commonly used in conjunction with network access and communication systems. The BA file in a user computer is preferably stored in a directory typically determined by the specific browser as a file or cluster of files. The BA file is a cluster of data streams that are formatted in a manner that are commonly used in network communication systems.

It should be noted that as used herein, a network browser session is taken to be synonymous with the viewing window of a network browser. The session (window) generally includes tool bars and icons typically used in browser programs.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

We claim:

1. A method of providing to a user computer connected to a network an advertisement for a network browser session, the method comprising the steps of:
a) requesting a new network data stream for display in the first network browser session;
b) serving up to a second network browser session an advertisement data stream previously stored in the memory of the user computer connected to the network thereby forming an advertisement;
c) downloading to the user computer, from a server on the network, the requested new network data stream which is viewable in the first network browser session; wherein, the advertisement is served up while the new network data stream is being downloaded to the user computer, the advertisement data stream was downloaded onto the memory of the user computer prior to the step of requesting a new network data stream, and the first and second network browser sessions are the same session or different sessions.

2. The method of claim 1 further comprising the step of:
a) storing the advertisement data stream in the memory of the user computer while waiting for a previous network data stream to download to the computer or while a previous network data stream was displayed in the browser session;
which step occurs prior to the requesting step.

3. The method of claim 2, wherein the first and second network browser sessions are the same.

4. The method of claim 3, wherein the window of the network browser session is a multi-frame window, and step c) comprises the step of serving up to one or more frames of the multi-frame window the advertisement data stream previously stored in the memory of the user computer connected to the network.

5. The method of claim 4, wherein the one or more frames that contain the served up advertisement data stream together comprise at least a major portion of the window of the network browser session.

6. The method of claim 2, wherein the first and second network browser sessions are different.

7. The method of claim 6, wherein the window of the second network browser session comprises a multi-frame window, and step c) comprises the step of serving up to one or more frames of the multi-frame window the advertisement data stream previously stored in the memory of the user computer connected to the network.

8. The method of claim 7, wherein the one or more frames that contain the advertisement data stream together comprise at least a major portion of the window of the second network browser session.

9. The method of claim 6, wherein the window of the second network browser session comprises a single frame window.

10. The method of claim 9, wherein the advertisement comprises at least a major portion of the single frame window.

11. The method of claim 2 further comprising the step of:
a) requesting from a server on the network a second advertisement; which step occurs concurrently with or after completion of the step of downloading of the requested new network data stream.

12. The method of claim 11 further comprising the step of:
a) storing the second advertisement data stream in the memory of the computer and deleting the first advertisement from the memory of the computer;
which step occurs after initiation of the step of requesting the second advertisement.

13. The method of claim 11, wherein the requested network data stream comprises software language that requests the second advertisement.

14. The method of claim 1, wherein the requested network data stream comprises software language that requests the second advertisement.

15. The method of claim 2 further comprising the step of:
a) activating one or more links in the advertisement.

16. The method of claim 1 further comprising the step of:
d) serving up to the first network browser session the requested network data stream, which step can occur after step b) or step c).

17. An electronic advertising system comprising:
a) plural network servers, at least a first server of which includes plural advertisement (BA) data streams stored in a first memory and at least a second server of which includes plural network data streams in a second memory; and
b) plural user computers, each of which comprises a third memory, a display component, a browser program, and an integrated circuit and each of which comprises a respective first BA data stream in the third memory; wherein,
c) the plural servers and plural user computers form a network;
d) the browser program and central processing unit can process BA data streams and network data streams for display; and
e) the browser program of a first user computer serves up the first BA data stream to a window for display as a first advertisement during the approximate period of time that occurs between when the first user computer requests a second network data stream from the second server and the second network data stream is completely downloaded onto the first user computer.

18. The system of claim 17, wherein the first BA data stream is replaced with a second BA data stream obtained from the first server after the second network data stream has been completely downloaded or while the second network data stream is being downloaded onto the user computer.

19. The system of claim 17, wherein at least one of the plural network data streams comprises embedded code identifying a specific BA data stream to be downloaded onto the user computer.

20. The system of claim 17, wherein at least one of the plural network data streamss comprises embedded code requesting an unspecified BA data stream to be downloaded onto the user computer, wherein the unspecified BA data stream belongs to a specific genus, group, subgroup, class and/or subclass of BA data streams.

21. The system of claim 17, wherein the browser program is displaying at least two windows, a first window of which includes the first advertisement and a second window of which includes the first or second network data streams.

22. The system of claim 17, wherein the browser program is displaying a single window comprising the first advertisement or the first or second network data streams.

23. The system of claim 22, wherein the first advertisement is included in the window approximately until the point in time that the second network data stream is ready for display.

24. An electronic advertisement for a network, wherein the advertisement comprises one or more advertisement portions displayed in a window of a browser program of a user computer and the advertisement is:
a) displayed in the window during the approximate period of time beginning about when the user computer requests a first network data stream from a network server and ending about when the first network data stream is downloaded onto the user computer and is ready for viewing as a first network data stream in the same or a different window of the browser; and
b) created from an advertisement data stream previously stored in the memory of the user computer, the advertisement data stream having been obtained from a network server prior to the point in time in which the user computer requests the first network data stream, wherein the advertisement portion is viewable, audible or a combination thereof.

25. The advertisement of claim 24, wherein the advertisement comprises a major portion of the window.

26. The advertisement of claim 24, wherein the first network data stream and the advertisement are in two different windows.

27. The advertisement of claim 24, wherein the first network data stream and the advertisement are in the same window.

28. The advertisement of claim 24, wherein at least one of the plural network data streams comprises embedded code identifying a specific BA data stream to be downloaded onto the user computer.

29. The advertisement of claim 24, wherein at least one of the plural network data streams comprises embedded code requesting a BA data stream but not identifying a specific BA data stream.

30. The advertisement of claim 24, wherein the BA data stream is a data stream cluster comprising two or more data stream types selected from the group consisting of html file, text file, graphics file, executable script, java script file, active-X file, flash file, multi-media file, video file, music file, audio file, CGI script, macro-media director file, Real file, QuickTime file, mpeg file, tiff file, gif file, pdf file, MIDI file, and plug-in file.

31. A method of advertising on a network comprising the steps of:
a) providing at least one first network server comprising a first memory having a plurality of advertisement (BA) data streams stored therein;
b) providing at least one second network server comprising a second memory having a plurality of network data streams stored therein, wherein at least one of the network data streams includes a BA activation code;
c) providing at least one user computer comprising a third memory, an integrated circuit unit, a browser program and a display component;
d) submitting a request from the user computer to the second network server for a first network data stream that includes a BA activation code;
e) downloading the requested first network data stream from the second network server to the user computer such that a first network data stream is displayed in a first window of the browser program and;
f) submitting a request to the first network server for a first BA data stream, wherein the request is initiated by the BA activation code; and
g) downloading the first BA data stream from the first network server to the user computer such that the first BA data stream is stored in the third memory, wherein the first and second windows are the same or different.

32. The method of claim 31 further comprising the steps of:
h) submitting a request from the user computer to the second network server for a second network data stream that optionally includes a BA activation code;
i) serving up the first BA data stream stored in the third memory to the browser program such that an advertisement is viewable in a second window of the browser program;
j) downloading the requested second network data stream from the second network server to the user computer such that a second network data stream is displayed in the first window of the browser program; and
k) displaying the requested second network data stream at a higher status than the advertisement.

33. The method of claim 32 further comprising the steps of:
l) submitting a request from the user computer to the first network server for a second BA data stream, wherein the request is initiated by a BA activation code embedded in second network data stream; and
m) downloading the second BA data stream from the first network server to the user computer such that the second BA data stream is stored in the third memory.

34. The method of claim 32, wherein the first and second windows are different windows and the first window remains open and the second window is closed.

35. The method of claim 32, wherein the first and second windows are stacked and are different windows and the first window is anterior to the second window.

36. The method of claim 32, wherein the first and second windows are tiled and are different windows and the first window is superior to the second window.

37. The method of claim 32, wherein the first and second windows are the same.

38. The method of claim 37, wherein the content of the network data stream is superior to the content of the BA.

39. The method of claim 32, wherein the third memory of the at least one user computer comprises a second BA data stream prior to the step d).

40. The method of claim 39 further comprising the steps of:
h) replacing the second BA data stream with the first BA data stream.

41. The method of claim 40 further comprising the steps of:
i) submitting a request from the user computer to the second network server for a second network data stream that optionally includes a BA activation code;
j) serving up the first BA data stream stored in the third memory to the browser program such that an advertisement is viewable in a second window of the browser program;
k) downloading the requested second network data stream from the second network server to the user computer such that a second network data stream is viewable in the first window of the browser program; and
l) displaying the first window at a higher status than the second window.

42. The method of claim 41 further comprising the steps of:
m) submitting a request from the user computer to the first network server for a third BA data stream, wherein the request is initiated by a BA activation code embedded in second network data stream; and
n) downloading the third BA data stream from the first network server to the user computer such that the third BA data stream is stored in the third memory and replaces the first BA data stream.
